(19) United States
(12) Patent Application Publication
(10) Pub. No.: US 2024/0075435 A1
(43) Pub. Date: Mar. 7, 2024

(54) MIXING DEVICE WITH CIRCULATION ZONE AND ASSOCIATED METHOD

(71) Applicants: QFLUIDICS, STRASBOURG (FR); Université de Strasbourg, STRASBOURG (FR); Centre national de la recherche scientifique, PARIS (FR)

(72) Inventors: Vincent Pascal MARICHEZ, BISCHEIM (FR); Thomas HERMANS, STRASBOURG (FR); Caroline Julie THEBAULT, STRASBOURG (FR); Lucas Jean Daniel GIACCHETTI, VENDENHEIM (FR)

(21) Appl. No.: 18/462,100

(22) Filed: Sep. 6, 2023

(30) Foreign Application Priority Data
Sep. 7, 2022 (FR) 2208946

(51) Int. Cl. B01F 25/31; B01F 25/314; B01F 33/451

(52) U.S. Cl. CPC B01F 25/311; B01F 25/314; B01F 33/451

(57) ABSTRACT

Disclosed is a mixing device including a chamber defining a circulation zone, the circulation zone including at least one base liquid and a mixing fluid, the mixing fluid being less paramagnetic than the base liquid, the mixing fluid including and/or consisting of at least one first fluid, the mixing device including at least one magnetic element which generates a magnetic field in the circulation zone so that the mixing fluid flows into the base liquid, the chamber including at least one first injection point of the first fluid into the circulation zone, the first injection point opening into the base liquid.

### CROSS-REFERENCE TO RELATED APPLICATION

This application claims the priority under 35 USC 119(a) of French patent application FR 22 08946 filed on Sep. 7, 2022, the entirety of which is incorporated herein by reference. The present invention relates to a mixing device and an associated mixing method.

### BACKGROUND OF THE INVENTION

### Field of the Invention

A mixing device is used for mixing e.g. two liquids which react together.

### Description of the Related Art

Such a mixing device is e.g. a microreactor with a Y-link, wherein the two reactants arrive via a respective branch and merge into a single branch.

The channels of the microreactor have e.g. a diameter comprised between 50 μm and 1 mm with flow rates generally less than 10 mL/minute, which corresponds to a small Reynolds number.

Thereby, the flow in the channels is laminar, so that the two liquids mix more by diffusion than by convection.

For example, it takes about 250 seconds for a molecule of solvent to cross the distance of a 1 mm channel by diffusion only, and hence about 250 seconds to consider that two aqueous liquids are mixed in the case of a junction of two liquids in a 1 mm channel, in the particular case of a mixing by diffusion only, under purely laminar condition with very low Reynolds number.

To improve the mixing between the two reagents, it is e.g. possible to add a static micro-mixer or an active mixer after the merging of the two reagents.

However, the proper functioning of such a microreactor is compromised by the appearance of solids, e.g. by the formation of a precipitate. Such a microreactor is thereby likely to be blocked by solids, particularly given the size of the channels.

Therefore, a goal of the invention is to propose a mixing device apt to mix fluids rapidly and to manage the possible appearance of solids.

### SUMMARY OF THE INVENTION

To this end, the subject matter of the invention is a mixing device, comprising a chamber defining a circulation zone, the circulation zone comprising at least one base liquid and one mixing fluid, the mixing fluid being less paramagnetic than the base liquid, the mixing fluid comprising and/or consisting of at least one first fluid, the mixing device comprising at least one magnetic element generating a magnetic field in the circulation zone so that the mixing fluid flows within the base liquid, the chamber comprising at least a first injection point of the first fluid into the circulation zone, the first injection point opening into the base liquid or into the mixing fluid, preferentially into the base liquid, the first fluid being immiscible with the base liquid.

The liquid walls formed by the base liquid are apt to manage the solids, without blocking the circulation zone.

In addition, preferentially, the injection of the at least one first fluid into the base liquid results in a more efficient mixing than a conventional microreactor, as will be described in greater detail thereafter.

According to other particular embodiments of the invention, the mixing device has one or a plurality of the following features, taken individually or according to all technically possible combinations:
the mixing fluid comprises and/or consists of at least one second fluid, the chamber comprising a second injection point of the second fluid into the circulation zone, the second injection point opening into the base liquid;
the first injection point and the second injection point are arranged on both sides of the chamber in a transverse direction of the chamber;
the first fluid and the second fluid have the same paramagnetic characteristics;
the at least one first injection point is arranged on a contour of the circulation zone;
at least one magnetic element comprises a magnetic multipole at least partially surrounding the chamber, the magnetic multipole being suitable for generating a magnetic field such that the magnetic field has a minimum value in the circulation zone at the center of said circulation zone;
at least one magnetic element comprises an additional element arranged at a closed end of the chamber;
the base liquid is a ferrofluid;
the mixing fluid comprises and/or consists of at least one second fluid, the chamber comprising a second injection point of the second fluid into the circulation zone, the second injection point being arranged on a contour of the circulation zone; and/or
the second injection point is arranged at one end of the chamber, said end being one end of the chamber along a direction of circulation.

The invention further relates to a mixing method comprising the following steps:
feeding of a mixing device such as described hereinabove,
injection of the at least first fluid into the circulation zone via the at least one first injection point, the first fluid being immiscible with the base liquid.

The mixing method is e.g. such that in the circulation zone, a chemical method amongst an acid-base reaction, an oxidation reaction, a reduction reaction, an amidation reaction, a condensation reaction, a hydrolysis reaction, a cyanation reaction, a coupling reaction, an esterification reaction, a halogenation reaction, an organic reaction, or an inorganic reaction, is carried out.

According to a particular embodiment of the invention, the mixing method comprises the following features: [in] the mixing device, in the circulation zone between the first fluid and the second fluid, at least one reaction involving precipitation and/or crystallization and/or peptization and/or flocculation and/or aggregation and/or polymerization and/or a reaction involving a solid heterogeneous catalyst. and/or a reaction wherein the reagent is solid, is carried out.

### BRIEF DESCRIPTION OF THE DRAWINGS

Other features and advantages of the invention will appear upon reading the following description, given only as an example, and making reference to the enclosed drawings, wherein:

FIG. 1 is a section view along the plane A of a first example of mixing device according to the invention,

FIG. 2 is a section view along the plane B of the mixing device shown in FIG. 1,

FIG. 3 is a side view of the mixing device shown in FIG. 1,

FIG. 4 is an example of the distribution of the magnetic field strength for a mixing device according to the invention,

FIG. 5 is a section view along the plane V of a second example of the mixing device according to the invention,

FIG. 6 is a section view along the plane VI of the mixing device shown in FIG. 5.

### DETAILED DESCRIPTION

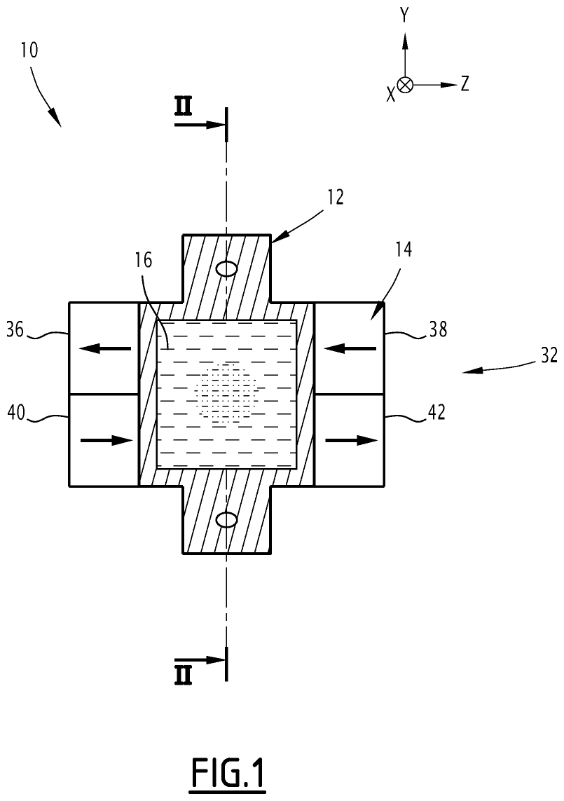

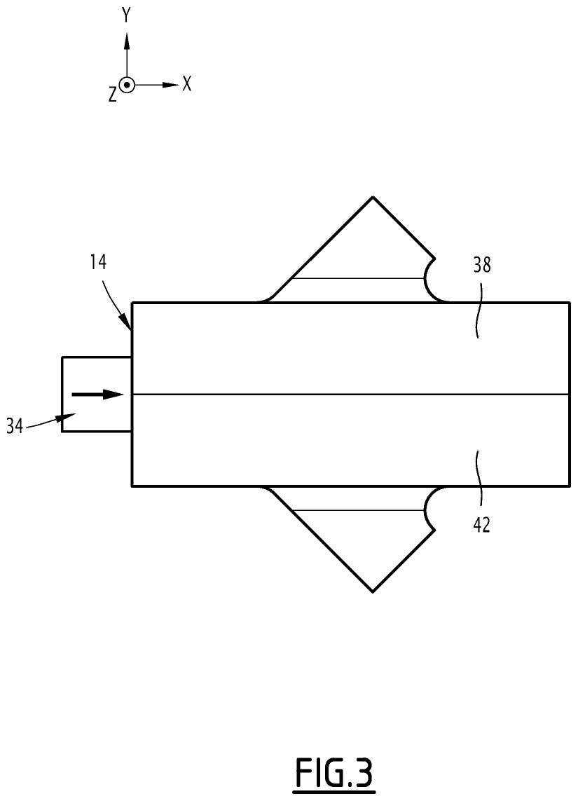

A mixing device according to a first embodiment of the invention is shown in FIGS. 1 and 3.

The mixing device 10 comprises a chamber 12 and at least one magnetic element 14.

The chamber 12 defines a circulation zone 16.

The circulation zone 16 extends along a direction of circulation X.

Herein, the terms “upstream” and “downstream” are defined along the direction of flow X along the general direction of flow of the fluid in the circulation zone 16.

The circulation zone 16 has any desired shape.

The circulation zone 16 has e.g. a section which is invariable along the direction of circulation X.

The circulation zone 16 is e.g. a cylinder with a base.

The base is e.g. cylindrical. Alternatively, the base is square, as shown, or rectangular.

In one embodiment, the circulation zone has a circular base, e.g. with a diameter of 3 mm.

The chamber 12, and thereby the circulation zone 16, comprises a closed end 18, herein along the direction of circulation X.

The closed end 18 corresponds herein to an upstream end of the circulation zone 16.

On the opposite side along the direction of circulation X, the chamber 12 comprises an open end, called a downstream end, e.g. coupled to another device.

The circulation zone 16 comprises a dimension along the direction of circulation X, comprised between 1 cm and 100 m.

The circulation zone 16 comprises at least one base liquid 20 and a mixing fluid 22, herein a base liquid 20 and a mixing fluid 22.

The mixing fluid 22 is e.g. a liquid, including e.g. a liquid emulsion, or a solid-laden liquid, e.g. called a “slurry”, or a gas.

The mixing fluid 22 is less paramagnetic than or has a paramagnetic susceptibility lower than the base liquid 20.

The liquid 20 is e.g. a ferrofluid.

Alternatively, the base liquid 20 is any other type of paramagnetic liquid, e.g. such as one of the following materials paramagnetic at room temperature: copper sulphate, other ferrous salts, palladium or platinum.

Alternatively, the base liquid 20 is a solution containing rare earth ions, such as Gd3+, Tb3+, Dy3+, Ho3+, Er3+, Tm3+.

Other examples of possible base liquid 20 comprise substances having persistent radicals such as nitroxides as TEMPO (2,2,6,6-tetramethylpiperidin-1-yl)oxyl), ionic liquids of transition metals or of lanthanides, such as [PR4] 2[CoCl 4] where [PR4] is trihexyl(tetradecyl)phosphonium, liquid crystals containing lanthanides, such as [Dy(LH)3(no3)3 where LH is the ligand of the Schiff base, rare earth metals or stable carbenes (triplet).

The mixing fluid 22 comprises and/or consists of at least a first fluid, herein a first fluid and a second fluid.

The first fluid and the second fluid are each less paramagnetic than the base fluid.

The first fluid and the second fluid are e.g. diamagnetic.

Each of the first fluid and the second fluid, respectively, is e.g. immiscible with the base liquid.

The first fluid and the second fluid have e.g. the same paramagnetic characteristics.

The first fluid is e.g. a liquid, a gas or a solid-laden liquid.

The second fluid is e.g. a liquid, a gas or a solid-laden liquid.

In one embodiment, at least one amongst the first fluid and the second fluid is a liquid or a solid-laden liquid, and the mixing fluid is a liquid or a solid-laden liquid.

The mixing fluid 22 flows within the base liquid, by means of the at least one magnetic element 14 described hereinafter.

More particularly, the base liquid 20 surrounds the mixing fluid, herein the liquid, radially around the direction of circulation X, and herein advantageously at the closed end 18.

The mixing fluid 22 is not in contact with the internal walls delimiting the circulation zone 16.

Herein, the mixing fluid 22 forms a circular cylindrical flow within the base liquid.

Alternatively, the mixing fluid 22 forms a cylindrical flow with a triangular or square base within the base liquid.

The flow has a diameter comprised between 10 μm and 10 cm, more particularly between 100 μm and 1 mm, e.g. equal to 1 mm.

The base liquid layer 20 covering the closed end 18 has e.g. a dimension along the direction of flow X greater than or equal to 10 μm, e.g. greater than or equal to 0.5 mm.

The chamber 12 comprises at least a first point of injection of the first fluid into the circulation zone 16, herein a first point of injection 24 of the first fluid and a second point of injection 26 of the second fluid.

A first feed line 28 feeding with the first fluid opens into the circulation zone at the first injection point 24.

The first injection point 24 is e.g. coupled to a source of first fluid.

A second feed line 30 feeding with the second fluid opens into the circulation zone at the second injection point 24.

The second injection point 26 is e.g. coupled to a source of second fluid.

Each injection point 24, 26 opens into the base liquid 20.

More particularly, each injection point 24, 26 is arranged on a contour of the circulation zone 16.

Each injection point 24, 26 is e.g. arranged in a respective wall of the chamber 12 delimiting the circulation zone 16.

More particularly, each feed line 28, 30 opens out at the respective wall.

In the embodiment shown, the first injection point 24 and the second injection point 26 are arranged on both sides of the chamber, e.g. herein along a transverse direction Y of the chamber 12, the transverse direction Y of the chamber 12 being perpendicular to the direction of circulation X.

More particularly, the first injection point 24 and the second injection point 26 are aligned along the transverse direction Y.

Each feed line 28, 30 is oriented such that the feed line points upstream of the circulation zone 16 when the feed line opens out.

Alternatively, each feed line 28, 30 is oriented downstream of the circulation zone when the line opens out, so that the fluid flow has an overall Y-shape.

Each feed line 28, 30 has a respective direction of feeding D1, D2.

The respective direction of feeding D1, D2 extends in a plane parallel to the transverse direction Y and to the direction of circulation X.

More particularly herein, the directions of feeding extend herein in a single plane.

The respective direction of feeding D1, D2 each forms a respective angle α, β with the direction of circulation X.

The angles α, β are e.g. comprised between 20° and 90°.

The angles α, β are e.g. equal.

The chamber 12 is, herein, e.g. symmetrical with respect to a median plane P.

In the example shown, the median plane P is parallel to the direction of circulation X and, in addition herein, to a latitudinal direction Z, the latitudinal direction Z being perpendicular to the direction of circulation X and to the transverse direction Y.

Each feed line has herein a diameter comprised between 100 μm and 1 mm, herein substantially equal to 0.8 mm.

In an alternative embodiment, the injections at the first injection site and at the second injection site are each oriented along the latitudinal direction Z.

In an alternative embodiment (not shown), the chamber comprises strictly more than two injection points, similar to the first and second injection points described hereinabove, the mixing fluid comprising and/or consisting of all the fluids injected at the injection points.

The at least one magnetic element 14 generates a magnetic field in the circulation zone so that the mixing fluid, herein a liquid, flows within the base liquid, as described hereinabove, more particularly, such that the base liquid 20 surrounds the mixing fluid, herein a liquid, radially around the direction of circulation X, and herein advantageously at the closed end 18.

In the example shown, the at least one magnetic element 14 comprises a magnetic multipole, in the example shown a magnetic quadrupole 32, at least partially surrounding the chamber 12.

The at least one magnetic element 14 herein further comprises an additional element 34 arranged at the closed end 18.

Magnetic multipole 32 refers to a part or a set of parts forming an object (including e.g. formed by disjointed and distant parts), the object having a plurality of magnetic poles.

The magnetic multipole 32 extends over the entire extension of the chamber along the direction of flow X.

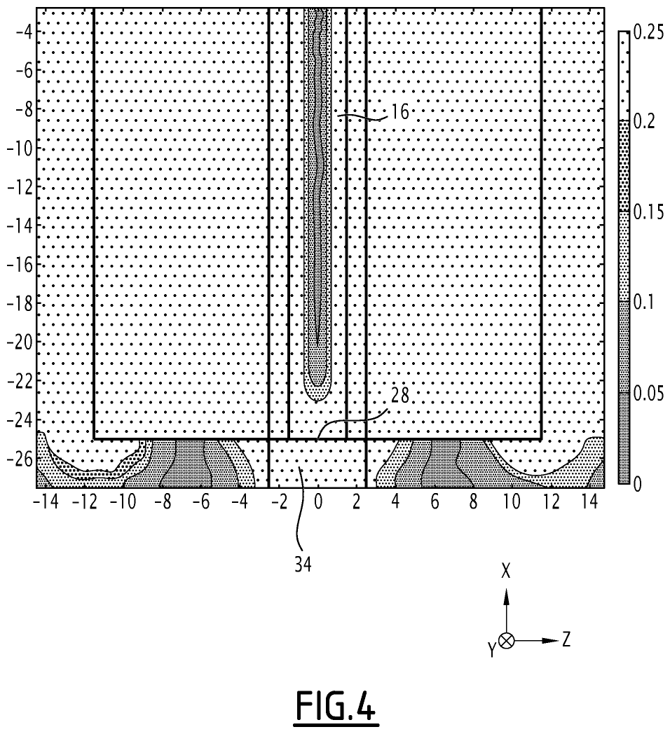

The magnetic multipole 32 is suitable for generating a magnetic field such that the magnetic field is the weakest at the center of the circulation zone 16, as shown in the example shown in FIG. 4.

The magnetic multipole 32 extends herein against external walls of the chamber, said walls being one end of the chamber along the latitudinal direction Z.

More particularly, the magnetic multipole 32 surrounds the circulation zone 16 along the direction of circulation X and the transverse direction Y.

In the embodiment shown, the magnetic multipole 32 comprises, more particularly is formed by, a plurality of magnets, e.g. four magnets.

For example, each magnet forms herein a pole of the magnetic multipole.

Alternatively, the magnetic multipole 32 comprises a plurality of magnets placed one after the other, herein along the direction of circulation X, in particular so as to cover the dimension of the circulation zone 16 along the direction of circulation X. For example, the magnetic multipole 32 comprises, more particularly consists of, a plurality of magnets, each pole of the magnetic multipole consisting of a plurality of magnets placed end-to-end along the direction of circulation.

Each magnet is e.g. a permanent magnet, e.g. a neodymium magnet, i.e. composed essentially of an alloy of neodymium, iron and boron, or a ferrite magnet, or a magnet composed mainly of aluminum, nickel and cobalt, called AlNiCo magnet, or a samarium-cobalt magnet, called SmCo magnet.

Each magnet is e.g. of grade N42.

Alternatively, each magnet is an electromagnet.

Alternatively, the magnetic multipole is made of a block, more particularly of a multipole magnet having, within said magnet, a plurality of magnetization directions.

Alternatively, the multipole is made of a plurality of multipole magnets each having, within said magnet, a plurality of magnetization directions.

In the example shown, the magnetic quadrupole 32 comprises two first magnets having a first magnetic orientation and two second magnets having a second magnetic orientation.

Each first magnet is arranged adjacent to one of the second magnets and opposite the other first magnet.

The first and second magnets each generate a magnetic field of the same intensity.

The intensity of the magnetic field is e.g. between 0 T and 5 T, more particularly herein between 0 T and 0.5 T.

The maximum intensity of the magnetic field, i.e. the intensity of the magnetic field at the location where the magnetic field is maximum, is e.g. greater than 1 mT, e.g. Comprised between 0.05 T and 0.5 T.

More particularly, in the example shown, the magnetic quadrupole 32 comprises two first magnets 36, 38 having a first magnetic orientation along the latitudinal direction Z and two second magnets 40, 42 having a second magnetic orientation along the latitudinal direction Z, the second magnetic orientation being the opposite of the first magnetic orientation.

The first magnets 36, 38 are arranged on both sides of the chamber 12 along the latitudinal direction Z.

The first magnets 36, 38 are, herein, spaced apart by a distance comprised between 50 μm and 10 cm, herein equal to 4 mm.

The first magnets 36, 38 are aligned along the latitudinal direction Z.

The second magnets 40, 42 are arranged on both sides of the chamber 12 along the latitudinal direction Z.

The second magnets 40, 42 are, herein, spaced apart by a distance comprised between 50 μm and 10 cm, herein equal to 4 mm.

The second magnets 40, 42 are aligned along the latitudinal direction Z.

Each first magnet 36, 38 is arranged next to a corresponding second magnet 40, 42 along the transverse direction Y.

Herein, there is no space between the first magnet 36, 38 and the corresponding second magnet 40, 42.

Alternatively, the first magnet 36, 38 and the corresponding second magnet 40, 42 are spaced apart by a distance less than or equal to 10 mm, more particularly less than or equal to 2 mm. The distance between the first magnet 36, 38 and the corresponding second magnet 40, 42 is e.g. less than the respective dimension of the magnets measured along the direction of said distance.

Each first magnet 36, 38 and the corresponding second magnet 40, 42 extends over all of the outer walls mentioned hereinabove.

In an alternative embodiment (not shown), the first magnets and the second magnets are arranged in a similar manner to the embodiment shown, however, the first magnets have a first magnetic orientation along the transverse direction Z and the second magnets have a second magnetic orientation along the transverse direction Z, the second magnetic orientation being the opposite of the first magnetic orientation.

In an alternative embodiment (not shown), the multipole comprises a number of poles, greater than or equal to three, whether or not equal to four.

The multipole is e.g. arranged around the chamber as shown in FIGS. 17 to 21 of the patent EP 3 571 405 B1.

The additional element 34 has a magnetic orientation along the direction of circulation X, so as to attract the base liquid 20 towards thereto.

The additional element 34 is e.g. an additional magnet.

The additional element 34 is arranged against the closed end of the chamber 18.

Herein, same is centered along the latitudinal Z and transverse Y directions with respect to the circulation zone 16.

The additional magnet 34 is e.g. a permanent magnet, e.g. a neodymium magnet, i.e. composed essentially of an alloy of neodymium, iron and boron, or a ferrite magnet, or a magnet composed mainly of aluminum, nickel and cobalt, called AlNiCo magnet, or a samarium-cobalt magnet, called SmCo magnet.

Alternatively, the additional magnet 34 is an electromagnet.

The magnetic field generated by the additional magnet 34 is herein maximum at the closed end 18 in the circulation zone 16.

An example is shown, in particular, in FIG. 4.

In particular, in this way it is possible that the base liquid 20 surrounds the mixing fluid, herein a liquid, at the closed end 18, so that the mixing fluid 22 is not in contact with the closed end 18.

The base liquid 20 forms a given thickness between the closed end 18 and the mixing fluid 22. The given thickness is e.g. comprised between 0 and 100 times the diameter of the flow of the mixing fluid, herein a liquid, more particularly comprised between 0.5 mm and 10 cm.

In an alternative embodiment (not shown), the mixing fluid, herein a liquid, consists of the first fluid only. The chamber comprises a single injection point for the first fluid. The first fluid is e.g. a multi-component fluid. The device of the invention can then be used e.g. for mixing the first fluid, so as to mix the plurality of components which compose the fluid.

In another alternative embodiment (not shown), the chamber comprises strictly more than two injection points for different fluids. The injection points are e.g., distributed across a plane perpendicular to the direction of circulation, on the periphery of the circulation zone. The mixing fluid, herein a liquid, is the mixture of the different fluids.

A mixing method will now be described with regard to the mixing device described hereinabove.

The mixing device 10 is provided.

In the example shown, the first fluid is injected into the circulation zone at the first injection point 24. Thereby, same flows into the base liquid 20.

In the example shown, the second fluid is injected into the circulation zone at the second injection point 26. Thereby, same flows into the base liquid 20.

Each of the first fluid and of the second fluid is driven by the base liquid 20 towards the center of the circulation zone 16, more particularly where the magnetic field is weakest.

In addition, each of the first fluid and of the second fluid is displaced by the base liquid 20 so as to move same away from the closed end 18.

The first fluid and the second fluid are thereby mixed at the central zone, more particularly at a distance from the closed end formed by the base liquid 20 and form the mixing fluid 22.

The mixing fluid 22 then flows along the direction of circulation X, surrounded by the base liquid 20.

In the embodiment wherein the chamber comprises strictly more than two injection points of different fluids, each of the different fluids is displaced by the base liquid towards the center of the circulation zone, and herein away from the closed end. The mixing between the different fluids is thereby enhanced.

In the embodiment wherein the chamber comprises a single fluid injection point, the latter is displaced by the base liquid towards the center of the circulation zone, and herein away from the closed end. A mixing of the first fluid, likely to accelerate reactions between different components of the first fluid, thereby results.

In the circulation zone, at least one reaction is carried out between the first fluid and the second fluid, involving at least one precipitation, as a target or secondary product, and/or a crystallization and/or a peptization and/or a flocculation and/or an aggregation and/or a polymerization, and/or a reaction involving a solid heterogeneous catalyst, and/or a reaction wherein the reactant is solid.

All of said reactions involve the management of solids by the mixing device.

In the present case, the presence of the base liquid allows the solids to be managed.

Indeed, unlike a static mixer wherein solids accumulate and block the flow of fluid, solids cannot accumulate against the base liquid by the liquid nature thereof. Similarly, the blades of an active mixer are prone to fouling.

Finally, the walls of microfluidic channels downstream of a conventional installation are subject to blocking, unlike the invention wherein the presence of the base liquid is used for discharging the solids.

Thereby, the mixing device does not become blocked by the presence of solids, but on the contrary allows the solids to circulate in the circulation zone.

The at least one reaction involving precipitation comprises e.g. one of the following reactions: formation of silver chloride (by reaction between sodium chloride and silver nitrate), reaction with Grignard compounds and/or organolithium reagents and/or organocopper compounds, precipitation of metals (e.g. Aluminum, Gallium, Thorium, Bismuth, Iron, and/or Tin), e.g. using urea, in water.

At least one reaction involving a solid heterogeneous catalyst comprises e.g. a reaction using palladium (Pd) as a catalyst, e.g. one of the following reactions:
an oxidation reaction, e.g. alcohol oxidations,
a reduction reaction, e.g. a selective hydrogenation, a reduction of the CC bond, a reduction of the CO moiety, a reduction of the nitro moiety, a decarbonylation, an imination, a reduction of the SO3H moiety, or a reduction of the nitrile moiety, or
a coupling reaction, e.g. one of the following reactions: Sonogashira, Hiyama, Glaser coupling, Ullmann reaction, cross-coupling cyclization, C—X coupling, or Suzuki-Miyaura.

At least one reaction involving a solid heterogeneous catalyst comprises e.g. a reaction using zeolites as catalyst, e.g. one of the following reactions: Hydrocracking, hydroxylation reaction of arenes to phenol, alkylation reaction of benzene, ammoximation of ketone, epoxidation of propylene, or isomerization of propylene oxide.

The at least one reaction involving a solid heterogeneous catalyst comprises, e.g. a reaction using nickel as a catalyst, e.g. one of the following reactions: cross-couplings of electrophilic alkyls or Suzuki-Miyaura coupling.

The at least one reaction involving a solid heterogeneous catalyst comprises, e.g. a reaction using gold (Au) as a catalyst, e.g, one of the following reactions: oxidation reaction, e.g. an oxidation of the CO moiety.

The at least one reaction involving a solid heterogeneous catalyst comprises, e.g. a reaction using platinum (Pt) as a catalyst, e.g. one of the following reactions: an oxidation reaction, e.g. an oxidation of the CO moiety or an oxidation of alcohols, or a reduction reaction, e.g. a selective hydrogenation.

The at least one reaction involving a solid heterogeneous catalyst comprises e.g. a reaction using ruthenium (Ru) as a catalyst, e.g, a reduction reaction, e.g. a selective hydrogenation.

The at least one reaction involving a solid heterogeneous catalyst comprises, e.g. a reaction using rhodium (Rh) as a catalyst, e.g. a hydroformilation reaction.

The at least one reaction wherein the reagent is solid comprises, e.g. a reaction of dissolving magnesium carbonate in nitric acid.

Like for solids, reactions involving highly viscous liquids are likely to be carried out in the mixing device according to the invention.

Such reactions are, e.g., polymerization reactions or the formation of colloids.

In the circulation zone, a chemical method is carried out, e.g. a chemical method from the list below:
an acid-base reaction, e.g. the reaction between sulfuric acid and potassium hydroxide; or
an oxidation reaction, e.g. the oxidation of primary, secondary or benzyl alcohol; or
a reduction reaction, e.g. an ester reduction reaction, a selective hydrogenation, a reduction of the CC bond, a reduction of the CO moiety, a reduction of the nitro moiety, a decarbonylation, an imination, a reduction of the SO3H moiety, or a reduction of the nitrile moiety; or
an amidation reaction, e.g. for peptide synthesis or cyclic molecule functionalization; or
a condensation reaction, e.g. for aldol condensation or an acylation; or
a hydrolysis reaction, e.g. the hydrolysis of ester, of acetal or of amide; or
a cyanation reaction, e.g. the functionalization of arenes by a nitrile moiety or the cyanation of aldehydes; or
a coupling reaction, e.g. one of the following reactions: Sonogashira, Hiyama, Glaser coupling, Ullmann reaction, cross-coupling cyclization, coupling C—X, or Suzuki-Miyaura coupling using a homogeneous catalyst; or
an esterification reaction, e.g. the esterification of carboxylic acid, of acid chloride or of acid anhydride; or
a halogenation reaction, e.g. brominations or chlorinations; or
another type of organic reaction, e.g. diazotization or cycloaddition reactions; or
an inorganic reaction, e.g. the formation of lithium hydroxide or of other metal salts.

### Example 1

The Villermaux-Dushman protocol is used for observing the mixing of reagents carried out by the mixing device.

Such protocol is explained in particular in the following document: Commenge, J.-M. & Falk, L. Villermaux-Dushman protocol for experimental characterization of micromixers. Chemical Engineering and Processing: Process Intensification 50, 979-990 (2011).

The first fluid comprises sulfuric acid or H2SO4. More particularly, the first fluid is an aqueous sulfuric acid solution having a molar concentration of 15 mM or millimolar.

The second fluid is a KI(aq)+KIO3 mixture in NaOH and H2BO3/H3BO3 (aq).

The second fluid is the mixture of a first solution and of a second solution.

The first solution comprises potassium iodide KI with a molar concentration of 16 mM, sodium hydroxide NaOH with a molar concentration of 45 mM and boric acid H3BO3 with a molar concentration of 45 mM.

The second solution comprises potassium iodate KIO3 with a molar concentration of 3 mM, sodium hydroxide NaOH with a molar concentration of 45 mM and boric acid H3BO3 with a molar concentration of 45 mM.

Two reactions take place concurrently when the second fluid is mixed with the first fluid within the microreactor.
a neutralization reaction of a buffer containing borate ions:

H2BO3--+H+→B(OH)3, and
an iodide-iodate reaction: IO3-+5 I-+6H+→3I2+3H2O followed by a triiodide reaction: I2+I-→I3.

The neutralization reaction is much faster than the iodide-iodate reaction.

The slowest reaction results in the production of triiodide, which can be detected by ultraviolet-visible (UV-Vis) spectroscopy.

If the mixing is good, the acid is consumed first by the first reaction. If the mixing is poor, the acid will be able to be consumed by the second reaction and form iodine which as such will form the triiodide ion which is detected using UV.

Thereby, the better the mixing between the fluids, the more the second reaction can occur before a complete mixing and the higher the signal detected by ultraviolet-visible spectroscopy.

It is possible to calculate the time tm for the complete mixing from the measured signal intensity S for a 1 mm optical travel and the initial concentrations of the individual components, by the following relationship:

tₘ=0.33×S×[H⁺]^{-4.55}×[KI]^{-1.5}×[KIO₃]^{5.8}×[NaOH]⁻²×[H₃BO₃]⁻²

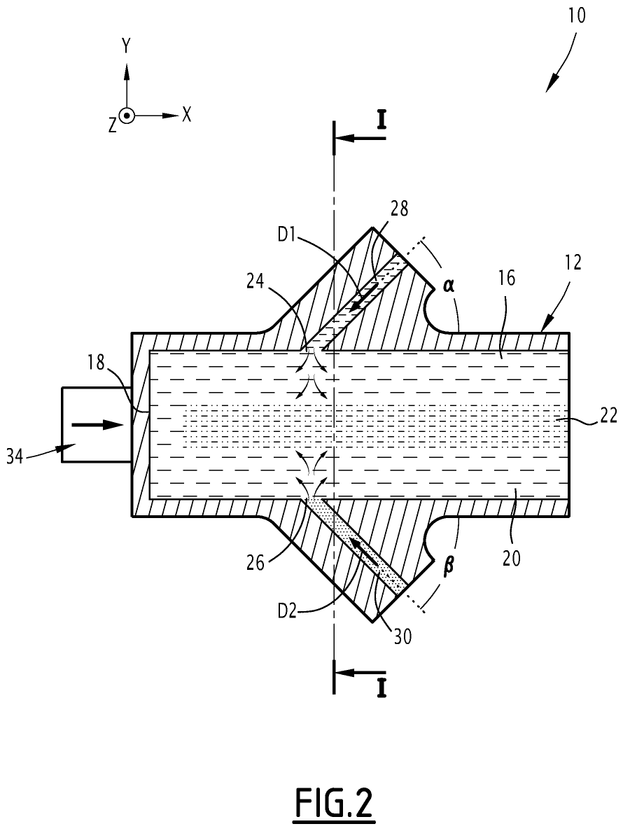

The example was implemented with a mixing device as described with reference to FIGS. 1 to 3 for a flow of the fluid, herein a liquid, of mixture having a diameter of 1 mm over a length of 5 cm. The base liquid forms a thickness of 0.75 mm between the closed end and the fluid, herein a liquid, of mixture. The magnets on both sides of the chamber are separated by a distance of 4 mm. The magnets are of grade N42.

In the example, a circulation zone with a circular base with a diameter equal to 3 mm is used.

The feed lines each have a diameter of 0.8 mm.

The above is compared to an LTF-MS microreactor and to an LTF-MX microreactor of the MR-lab series from Little Things Factory GmbH. Each of the microreactors has a circulation channel diameter equal to 1 mm.

For an overall flow-rate, i.e. of the first fluid and of the second fluid added together, of 0.4 mL/minute, the following is calculated:
for the mixing device of the invention, a time tm of 0.2 seconds,
for the LTF-MS microreactor, a time tm of 9 seconds, and
for the LTF-MX microreactor, a time tm of 10 seconds.

For an overall flow-rate of 1 mL/minute, the following is calculated:
for the mixing device of the invention, a time tm of less than 0.3 seconds,
for the LTF-MS microreactor, a time tm between 8 and 9 seconds, and
for the LTF-MX microreactor, a time tm of 6 seconds.

For an overall flow rate of 2 mL/minute, the following is calculated:
for the mixing device of the invention, a time tm of 0.3 seconds,
for the LTF-MS microreactor, a time tm between 6 and 7 seconds, and
for the LTF-MX microreactor, a time tm between 4 and 5 seconds.

Thereby, the mixing device of the invention can be used for faster mixing than the existing microreactors.

### Example 2

To observe the management of the solids by the mixing device, a second example is carried out.

The first fluid is sodium chloride in aqueous solution. The first fluid is injected with a flow-rate of 0.1 mL/minute.

The second fluid is ethanol. The second fluid is injected with a flow-rate of 0.1 mL/minute.

Mixing of the first fluid and the second fluid leads to a precipitation of the NaCl crystals.

Example 2 was implemented with a device similar to example 1.

The example was implemented with a mixing device as described with reference to FIGS. 1 to 3 for a flow of the fluid, herein a liquid, of mixture having a diameter of 1 mm over a length of 5 cm. The base liquid forms a thickness of 0.75 mm between the closed end and the fluid, herein a liquid, of mixture. The magnets on both sides of the chamber are separated by a distance of 4 mm. The magnets are of grade N42.

In the example, a circulation zone with a circular base with a diameter equal to 3 mm is used.

The feed lines each have a diameter of 0.8 mm.

The above is compared to an LTF-MS microreactor and to an LTF-MX microreactor of the MR-lab series from Little Things Factory GmbH. Each of the microreactors has a circulation channel diameter equal to 1 mm.

The circulation channel of the LTF-MS microreactor is blocked by the NaCl crystals in 2 minutes. The circulation channel of the LTF-MX microreactor is blocked by the NaCl crystals in 10 minutes.

The mixing device of the invention does not block and operates continuously for at least two hours, without the appearance of a plug. At the end of the two hours, the example was stopped, with no sign of foreseeable plug in the device of the invention.

Thereby, the mixing device of the invention makes a better management possible of solids than the existing microreactors.

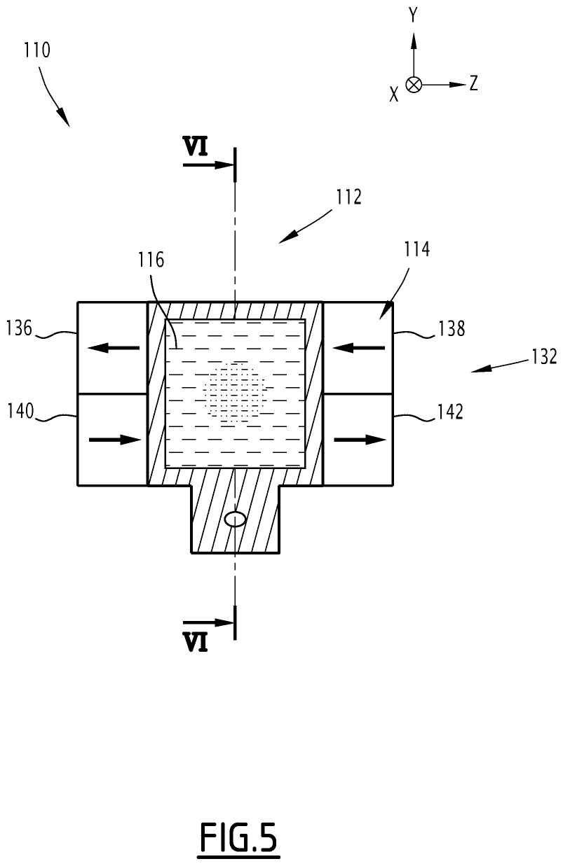

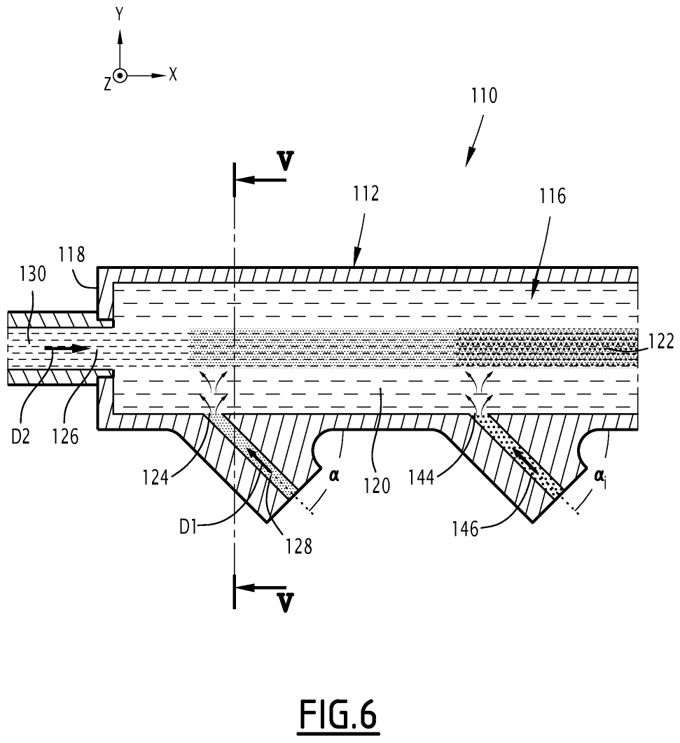

A second embodiment of a mixing device 110 according to the invention will now be described with reference to FIGS. 5 and 6.

The mixing device 110 comprises a chamber 112 and at least one magnetic element 114.

The chamber 112 defines a circulation zone 116.

The circulation zone 116 extends along a direction of circulation X.

Herein, the terms “upstream” and “downstream” are defined along the direction of flow X along the general direction of flow of the fluid in the circulation zone 16.

The circulation zone 116 has any desired shape.

The circulation zone 116 has e.g. a section which is invariable along the direction of circulation X.

The circulation zone 116 is e.g. a cylinder with a base.

The base is e.g. cylindrical. Alternatively, the base is square, as shown, or rectangular.

In one embodiment, the circulation zone has a circular base, e.g. with a diameter of 3 mm.

The chamber 112, and thereby the circulation zone 116, comprises an end 118 along the direction of circulation X.

The end 118 herein corresponds to an upstream end of the circulation zone 16.

The end 118 here has an opening, more particularly a single opening.

The opening is e.g. centered perpendicularly to the direction of circulation X with respect to the circulation zone 116.

Opposite the end 118 along the direction of flow X, the chamber 112 comprises an open end, called the downstream end, e.g. coupled to another device.

The circulation zone 116 comprises a dimension along the direction of circulation X, comprised between 1 cm and 100 m.

The circulation zone 116 comprises at least one base liquid 120 and a mixing fluid 122, herein a base liquid 120 and a mixing fluid 122.

The base liquid 20 and the mixing fluid 22 are as described hereinabove with regard to the first embodiment.

Similarly, the mixing fluid 122 flows within the base liquid 120, by means of the at least one magnetic element 114, described hereinafter.

More particularly, the base liquid 120 surrounds the mixing fluid radially around the direction of circulation X.

The mixing fluid 122 is not in contact with the internal walls delimiting the circulation zone 16.

Herein, the mixing fluid 122 forms a circular cylindrical flow within the base liquid.

Alternatively, the mixing fluid 122 forms a cylindrical flow with a triangular or square base within the base liquid.

The flow has a diameter comprised between 10 μm and 10 cm, more particularly between 100 μm and 1 mm, e.g. equal to 1 mm.

In the example shown, the chamber 112 comprises at least a first injection point 124 for the first fluid and a second injection point 126 for the second fluid.

The first injection point 124 is e.g. coupled to a source of first fluid.

A first feed line 128 feeding with the first fluid opens into the circulation zone at the first injection point 124.

The second injection point 126 is e.g. coupled to a source of second fluid.

A second feed line 130 for the second fluid opens out, e.g., into the circulation zone at the second injection point 124.

Alternatively, the source of second fluid comprises a tank having an internal volume comprising second fluid, the end 118 being arranged in the tank, such that the opening of the end 118 is arranged in the internal volume of the tank.

The internal volume of the tank and the circulation zone 116 are herein fluidly coupled at the opening.

The end 118 is e.g. coupled to the contents of the internal volume by a means for adjusting the fluid pressure, e.g. a pressure reducer.

The first injection point 124 opens into the base liquid 20.

Each injection point 124, 126 is arranged on a contour of the circulation zone 116.

Each injection point 124, 126 is e.g. arranged in a respective wall of the chamber 112 delimiting the circulation zone 116.

More particularly, each feed line 128, 130 opens out at the level of the respective wall.

In the embodiment shown, the first injection point 124 is arranged at the lateral wall of the chamber, delimiting the chamber 112 along a transverse direction Y, the transverse direction Y of the chamber 112 being perpendicular to the direction of circulation X.

In the embodiment shown, the second injection point 126 is arranged at the end 118, more particularly at the opening.

The first feed line 128 is, herein, oriented such that the line points upstream of the circulation zone 116 when said line comes out.

Alternatively, the first feed line 28 is oriented downstream of the circulation zone when said line comes out.

The second feed line 130 is, herein, oriented along the direction of circulation X.

The second feed line 130 is herein coupled in leak-tight way to the chamber 112 at the opening at the end 118, e.g. directly (as shown herein) or by means of a connector.

Each feed line 128, 130 has a respective direction of feeding D1, D2.

The respective direction of feeding D1, D2 extends in a plane parallel to the transverse direction Y and to the direction of circulation X.

More particularly herein, the directions of feeding extend herein in a single plane.

The respective direction of feeding D1, D2 each forms a respective angle α, β with the direction of circulation X.

The angle α is then e.g. comprised between 0° and 80°.

The angle β is herein zero.

The chamber 112 is, herein, e.g. symmetrical with respect to a median plane.

In the example shown, the median plane is parallel to the direction of circulation X and, in addition herein, to a latitudinal direction Z, the latitudinal direction Z being perpendicular to the direction of circulation X and to the transverse direction Y.

Each feed line has herein a diameter comprised between 100 μm and 1 mm, herein substantially equal to 0.8 mm.

In a particular embodiment, the chamber comprises strictly more than two injection points, the additional injection point(s) 144 being similar to the first injection point described hereinabove, the mixing fluid comprising and/or consisting of all the fluids injected at the injection points.

The additional injection point(s) 144 are, e.g., arranged after the first injection point 124.

The successive injections are then carried out in series.

The additional injection point(s) (144) are opening e.g. in the same side wall of the chamber as the first injection point.

Alternatively, the additional injection point(s) 144 are opening in any side wall of the chamber delimiting the chamber perpendicular to the direction of circulation X.

Each additional injection point 144 is fed by a corresponding feed line 146.

Each corresponding feed line 146 is e.g. oriented upstream of the circulation zone 116.

The respective direction of feeding of each additional injection point 144 forms an angle αi with the direction of circulation X.

The angle αi is then e.g. between 0° and 80°.

The angle αi is e.g. equal to the angle α.

Additionally or alternatively, at least one of the additional injection points opens into the end 118, e.g. at the opening or at an additional opening delimited by the end 118.

The end 118 then has e.g. an opening per injection point coming out into the end.

Alternatively, the end 118 has a single opening, more particularly centered, all the injection points being at said opening. Each injection point at the opening is e.g. coupled to a feed line, all of said feed lines being coupled to the opening in a leak-tight way.

The at least one magnetic element 114 generates a magnetic field in the circulation zone so that the mixing fluid flows within the base liquid, as described hereinabove, more particularly, such that the base liquid 120 surrounds the mixing fluid, herein a liquid, radially around the direction of circulation X,

In the example shown, the at least one magnetic element 114 comprises a magnetic multipole, in the example shown a magnetic quadrupole 132, at least partially surrounding the chamber 112.

Unlike the first example, the at least one magnetic element 114 lacks herein an additional element arranged at the end 118.

Herein, the magnetic multipole 132 is e.g. similar to same described with reference to the first embodiment.

In the example shown, the at least one magnetic element 114 consists of the magnetic multipole 132.

However, the at least one magnetic element 114 is likely to be present in any arrangement so as to generate a magnetic field in the circulation zone so that the mixing fluid flows within the base liquid, as described hereinabove, more particularly, such that the base liquid 120 surrounds the mixing fluid, e.g. a liquid, radially around the direction of circulation X.

Similarly to the first embodiment, the at least one magnetic element 114 makes it possible that the mixing fluid 122 does not come into contact with a physical wall delimiting the chamber 112, the mixing fluid 122 being surrounded by the base liquid 120.

The mixing device is thus suitable for mixing fluids rapidly and is, in particular, apt to manage the possible appearance of solids, if any, without interrupting the operation of the mixing device.

In an alternative embodiment (not shown), the injection point, if same is a single injection point, or each of the injection points otherwise, opens out at the end 118.

The injection points are arranged on a contour of the circulation zone.

Herein, each injection point opens out e.g. at the mixing fluid.

Each injection point does not open out opposite the base fluid.

More particularly, each injection point is arranged so as to open out at a distance from the center of the end; which is smaller than the diameter of the mixing fluid within the circulation zone.

In the case of a plurality of injection points, each injection point opens out at a respective opening delimited in the end 118.

Alternatively, the end 118 has fewer openings than injection points, at least two injection points opening out into the same opening.

The mixing device then has no injection points on the side walls of the chamber.

In an alternative embodiment (not shown), at least one injection point opens out directly into the mixing fluid, outside one end of the chamber along the direction of circulation.

More particularly, said injection point is coupled to a feed line, the feed line comprising a portion extending into the circulation zone, so that the feed line opens out directly into the mixing fluid.

In a particular embodiment, the device comprises e.g. only such injection points.

Alternatively, the device comprises at least one such injection point and at least one injection point at the end 118.

Alternatively or additionally, the device further comprises at least one injection point into the base liquid. Where appropriate, the fluid injected into the base liquid is displaced by the base liquid towards the center of the circulation zone, which enhances mixing between the different fluids, including the fluid(s) injected directly into the mixing fluid or at the end.

During the process, a fluid is injected at each injection point at the end. All the fluids meet directly at the mixing fluid, so that e.g. a reaction takes place.

Such mixing devices have poorer mixing qualities than when injected into the base liquid, but also make it possible to manage the possible appearance of solids, if any, without interrupting the operation of the mixing device, by the presence of the base fluid around the mixing fluid, which in particular makes it possible to manage the possible appearance of solids.

1. A mixing device comprising a chamber defining a circulation zone, the circulation zone comprising at least a base liquid and a mixing fluid, the mixing fluid being less paramagnetic than the base liquid, the mixing fluid comprising and/or consisting of at least one first fluid, the mixing device comprising at least one magnetic element generating a magnetic field in the circulation zone such that the mixing fluid flows within the base liquid, the chamber comprising at least a first injection point of the first fluid in the circulation zone, the first injection point opening into the base liquid or into the mixing fluid, the first fluid being immiscible with the base liquid.

2. The mixing device according to claim 1, wherein the mixing fluid comprises and/or consists of at least one second fluid, the chamber comprising a second injection point of the second fluid into the circulation zone, the second injection point opening into the base liquid.

3. The mixing device according to claim 2, wherein the first injection point and the second injection point are arranged on both sides of the chamber along a transverse direction of the chamber.

4. The mixing device according to claim 2, wherein the first fluid and the second fluid have the same paramagnetic characteristics.

5. The mixing device according to claim 1, wherein the at least one first injection point is arranged on a contour of the circulation zone.

6. The mixing device according to claim 1, wherein the at least one magnetic element comprises a magnetic multipole at least partially surrounding the chamber, the magnetic multipole being suitable for generating a magnetic field such that the magnetic field has a minimum value in the circulation zone at the center of said circulation zone.

7. The mixing device according to claim 1, wherein the at least one magnetic element comprises an additional element arranged at a closed end of the chamber.

8. The mixing device according to claim 1, wherein the base liquid is a ferrofluid.

9. The mixing device according to claim 1, wherein the mixing fluid comprises and/or consists of at least one second fluid, the chamber comprising a second injection point of the second fluid into the circulation zone, the second injection point being arranged on a contour of the circulation zone.

10. The mixing device according to claim 9, wherein the second injection point is arranged at an end of the chamber, said end being an end of the chamber along a flow direction.

11. A mixing method comprising:
providing a mixing device according to claim 1,
injecting the at least first fluid into the circulation zone via the at least one first injection point, the first fluid being immiscible with the base liquid.

12. The mixing method according to claim 11, wherein, in the circulation zone, a chemical method amongst an acid-base reaction, an oxidation reaction, a reduction reaction, an amidation reaction, a condensation reaction, a hydrolysis reaction, a cyanation reaction, a coupling reaction, an esterification reaction, a halogenation reaction, an organic reaction, or an inorganic reaction, is produced.

13. The mixing method according to claim 11, wherein the mixing fluid comprises and/or consists of at least one second fluid, the chamber comprising a second injection point of the second fluid into the circulation zone, the second injection point opening into the base liquid, and wherein at least one reaction involving precipitation and/or crystallization and/or peptization and/or flocculation and/or aggregation and/or polymerization and/or reaction involving a solid heterogeneous catalyst is produced in the circulation zone between the first fluid and the second fluid, and/or a reaction wherein the reagent is solid.
